(19) United States
(12) Patent Application Publication
(10) Pub. No.: US 2024/0181992 A1
(43) Pub. Date: Jun. 6, 2024

(54) FOREIGN MATTER REMOVAL DEVICE AND A METHOD OF OPERATING THE SAME

(71) Applicants: HYUNDAI MOTOR COMPANY, Seoul (KR); KIA CORPORATION, Seoul (KR)

(72) Inventor: Young Dug Yang, Seoul (KR)

(73) Assignees: HYUNDAI MOTOR COMPANY, Seoul (KR); KIA CORPORATION, Seoul (KR)

(21) Appl. No.: 18/203,858

(22) Filed: May 31, 2023

(30) Foreign Application Priority Data
Dec. 5, 2022 (KR) 10-2022-0167271

(51) Int. Cl. B60S 1/48; B60S 1/50; B60S 1/52

(52) U.S. Cl. CPC B60S 1/481; B60S 1/50; B60S 1/52

(57) ABSTRACT

A foreign matter removal device for an environmental sensor and a method of operating the same. The device includes the environmental sensor including a hydrophobic layer on the surface thereof and a plurality of electrodes disposed under the hydrophobic layer, wherein a voltage is applicable to the plurality of electrodes, and a nozzle configured to spray a fluid to the environmental sensor, wherein the voltage is applied after the nozzle sprays the fluid.

### CROSS-REFERENCE TO RELATED APPLICATION

This application claims, under 35 U.S.C. § 119(a), the benefit of and priority to Korean Patent Application No. 10-2022-0167271, filed on Dec. 5, 2022, the entire contents of which are incorporated herein by reference.

### BACKGROUND

### (a) Technical Field

The present disclosure relates to a device and a method to clean a sensor.

### (b) Background Art

Recently, a driver assistance system that assists a driver of a vehicle is mounted in the vehicle in order to secure safe traveling in various traveling situations. In addition to the driver assistance system, research and development on a self-driving vehicle capable of driving itself without driver intervention is being actively conducted.

For such a driver assistance system, various types of environmental sensors capable of sensing a surrounding environment in various ways are mounted in a self-driving vehicle. Environmental sensors installed in the vehicle may be a radar, a lidar, a camera, and the like.

Because these sensors are mounted on the outer side of the vehicle, the sensing regions thereof may easily become dirty due to foreign matter, such as dust, rain, snow, or the like. Therefore, in order to maintain the performance of the sensors, these sensors must be kept clean at or above a predetermined level.

The above information disclosed in this Background section is provided only to enhance understanding of the background of the present disclosure, and therefore it may contain information that does not form the prior art that is already known to a person of ordinary skill in the art.

### SUMMARY OF THE DISCLOSURE

The present disclosure has been made in an effort to solve the above-described problems associated with the prior art, and it is an object of the present disclosure to provide a foreign matter removal device capable of effectively cleaning an environmental sensor, and a method of operating the same.

The object of the present disclosure is not limited to the above-mentioned object, and other objects not mentioned herein should be clearly understood by those of ordinary skill in the art to which the present disclosure pertains (hereinafter, “those skilled in the art”) based on the description below.

In one aspect, the present disclosure provides a foreign matter removal device for an environmental sensor. The device includes the environmental sensor including a hydrophobic layer on the surface thereof and a plurality of electrodes disposed under the hydrophobic layer, wherein a voltage is applicable to the plurality of electrodes receives a voltage. The device further includes a nozzle configured to spray a fluid to the environmental sensor and the voltage is applied after the nozzle sprays the fluid.

In another aspect, the present disclosure provides a method of operating a foreign matter removal device for an environmental sensor. The method is executable by a controller (e.g., a processor). The method includes detecting whether foreign matter is attached to the environmental sensor. In particular, the environmental sensor comprises a hydrophobic layer on a surface thereof and a plurality of electrodes disposed under the hydrophobic layer. The plurality of electrodes receives a voltage. The method further includes spraying fluid to the environmental sensor using a nozzle upon determining that foreign matter is present on the environmental sensor, and alternately applying a first voltage and a second voltage, which are different from each other, to the electrodes.

In still another aspect, the present disclosure provides a method of operating a foreign matter removal device, the method being executable by a controller. The method includes detecting whether foreign matter in a non-liquid state is present on an environmental sensor, and spraying a washer fluid to the environment sensor through a nozzle. The environmental sensor includes a hydrophobic layer on a surface thereof and a plurality of electrodes disposed under the hydrophobic layer, and a voltage is applied to the plurality of electrodes. The method further includes adjusting voltages of the plurality of electrodes.

Other aspects and embodiments of the present disclosure are discussed below.

It is to be understood that the term “vehicle” or “vehicular” or other similar terms as used herein are inclusive of motor vehicles in general, such as passenger automobiles including sport utility vehicles (SUV), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g. fuels derived from resources other than petroleum). As referred to herein, a hybrid vehicle is a vehicle that has two or more sources of power, for example, a vehicle powered by both gasoline and electricity.

The above and other features of the present disclosure are discussed below.

### BRIEF DESCRIPTION OF THE DRAWINGS

The above and other features of the present disclosure are now described in detail with reference to certain embodiments thereof illustrated in the accompanying drawings which are given hereinbelow by way of illustration only, and thus are not limitative of the present disclosure, and wherein:

FIG. 1A is a block diagram illustrating a sensor cleaning system using compressed air according to an embodiment of the present disclosure:

FIG. 1B is a block diagram illustrating a sensor cleaning system using washer fluid according to an embodiment of the present disclosure:

FIG. 2 illustrates a schematic arrangement of environmental sensors and a sensor cleaning system on a vehicle according to an embodiment of the present disclosure;

FIG. 3 illustrates a foreign matter removal device according to an embodiment of the present disclosure;

FIG. 4A illustrates spraying at a particle position of a nozzle of a foreign matter removal device according to an embodiment of the present disclosure:

FIG. 4B illustrates spraying at a high pressure position of a nozzle of a foreign matter removal device according to an embodiment of the present disclosure;

FIG. 5 illustrates an environmental sensor according to some embodiments of the present disclosure;

FIG. 6 is a block diagram illustrating a foreign matter removal device according to an embodiment of the present disclosure; and

FIG. 7 is a flowchart illustrating the operation of a foreign matter removal device according to an embodiment of the present disclosure.

It should be understood that the appended drawings are not necessarily to scale, presenting a somewhat simplified representation of various features illustrative of the basic principles of the present disclosure. The specific design features of the present disclosure as disclosed herein, including, for example, specific dimensions, orientations, locations, and shapes, should be determined in part by the particular intended application and usage environment.

In the figures, reference numbers refer to the same or equivalent parts of the present disclosure throughout the several figures of the drawing.

### DETAILED DESCRIPTION

Descriptions of specific structures or functions presented in the embodiments of the present disclosure are merely exemplary for the purpose of explaining the embodiments according to the concept of the present disclosure, and the embodiments according to the concept of the present disclosure may be implemented in various forms. In addition, the descriptions should not be construed as being limited to the embodiments described herein, and should be understood to include all modifications, equivalents and substitutes falling within the idea and scope of the present disclosure.

Meanwhile, in the present disclosure, terms such as “first” and/or “second” may be used to describe various components, but the components are not limited by the terms. These terms are only used to distinguish one component from another. For example, a first component could be termed a second component, and similarly, a second component could be termed a first component, without departing from the scope of exemplary embodiments of the present disclosure.

In the present disclosure, when a component is referred to as being “connected to” another component, the component may be directly connected to the other component, or intervening components may also be present. In contrast, when a component is referred to as being “directly connected to” another component, there is no intervening component present. Other terms used to describe relationships between components should be interpreted in a like fashion (e.g. “between” versus “directly between,” “adjacent” versus “directly adjacent,” etc.).

Throughout the specification, like reference numerals indicate like components. The terminology used herein is for the purpose of illustrating embodiments and is not intended to limit the present disclosure. In this specification, the singular form includes the plural sense, unless specified otherwise. The terms “comprises” and/or “comprising” used in this specification mean that the cited component, step, operation, and/or element does not exclude the presence or addition of one or more of other components, steps, operations, and/or elements.

When a component, device, element, or the like of the present disclosure is described as having a purpose or performing an operation, function, or the like, the component, device, or element should be considered herein as being “configured to” meet that purpose or to perform that operation or function.

Hereinafter, the present disclosure is described in detail with reference to the accompanying drawings.

As described above, in order to maintain the performance of the environmental sensor configured to sense the surrounding environment of the vehicle, periodic cleaning of the surface of the sensor is needed. For example, the environmental sensor may be contaminated by solids, such as dust and sand, and may be stained by liquids, such as raindrops and snow during precipitation.

Particularly, in an active self-driving vehicle, the vehicle travels based on surrounding environment information, such as traffic lights, pedestrians, road types, buildings, and surrounding vehicles, recognized by environmental sensors. When the surface of the environmental sensor is contaminated, recognition of the surrounding environment and active self-driving become impossible. Therefore, a sensor cleaning system of the vehicle performs an important function of helping the environmental sensor to precisely recognize the surrounding environment without distortion and removing contaminants from the surface of the sensor, thereby enabling traveling of the vehicle.

Cleaning of the environmental sensor may be performed by a method of using a washer fluid or a method of using high-pressure air. In the former case, the sensor may be cleaned using a washer fluid and moisture on the sensor may be removed through air spray. In the latter case, foreign matter on the sensor surface is removed by spraying only high-pressure air.

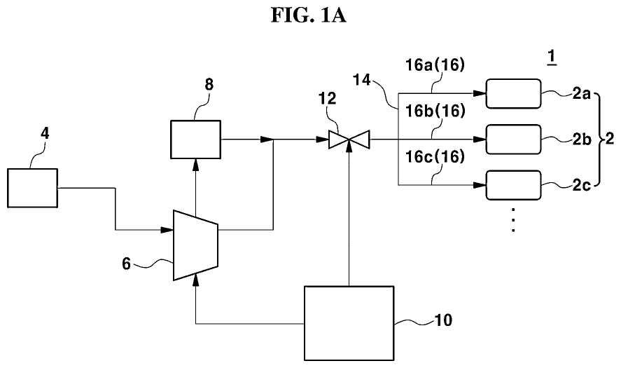

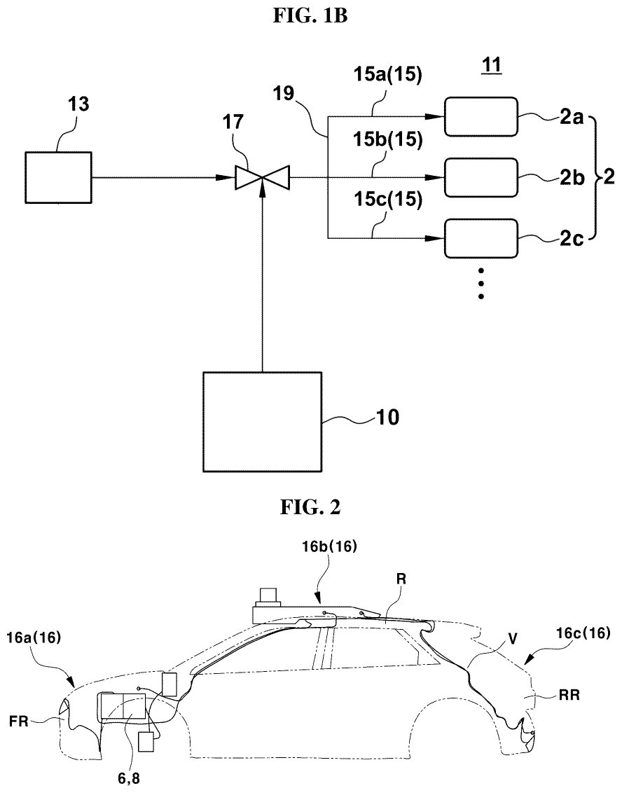

A sensor cleaning system using the latter method, the so-called air cleaning method, which cleans an environmental sensor by spraying compressed air, is described with reference to FIGS. 1A and 2. An air cleaning system 1 of the sensor cleaning system may clean the environmental sensor using compressed air. The air cleaning system 1 sprays compressed air on the surface of an environmental sensor 2 to perform cleaning. The environmental sensor 2 may include a sensing device, such as a lidar, a radar, and a camera, and may be disposed at the front region “FR”, rear region “RR”, side region, roof “R”, etc., of a vehicle “V”.

Specifically, air filtered through an air filter 4 provided in the vehicle is introduced into a compressor 6. The air is compressed in the compressor 6 and then injected to the surface of the environmental sensor 2 to thereby remove foreign matter on the environmental sensor 2. The environmental sensor 2 includes a plurality of environmental sensors 2a, 2b and 2c. Although three environmental sensors are disclosed in this specification and the drawings, the number of environmental sensors is not limited thereto and may be increased or decreased.

In addition, the air cleaning system 1 includes an air tank 8. Air compressed in the compressor 6 or air supplied by an external device may be filled in the air tank 8, and the air filled in the air tank 8 may be used for cleaning of the environmental sensor 2.

The air cleaning system 1 includes a controller 10 configured to operate a valve 12 (e.g., a solenoid valve) in a predetermined situation such as every preset period or when the environmental sensor 2 detects contamination. Accordingly, the compressed air is injected from the compressor 6 or from the air tank 8 to each of the environmental sensors 2, thereby cleaning the environmental sensors 2. The valve 12 is provided with or integrated with a distributor 14 to distribute the compressed air through nozzles 16a, 16b, 16c (collectively, 16) each for a corresponding one of the environmental sensors 2, as illustrated in FIG. 2.

Referring to FIG. 1B, in addition to the air cleaning system 1, a washer fluid cleaning system 11 may be provided in the vehicle V. Washer fluid is stored in a washer fluid tank 13. The washer fluid may be injected at a high pressure to the environmental sensor 2 through washer fluid nozzles 15a, 15b, 15c (collectively, 15) disposed around the environmental sensor 2. Particularly, a washer fluid valve 17 controllable by the controller 10 may be disposed between the washer fluid tank 13 and the washer fluid nozzles 15 (15a, 15b, 15c). When the washer fluid valve 17 is open, the washer fluid may be directed to each of the washer fluid nozzles 15 (15a, 15b, 15c) through a washer fluid distributor 19. In some embodiments, the washer fluid valve 17 may be integrated with the washer fluid distributor 19. In the illustrated embodiment, the number of environmental sensors 2 or nozzles 15 is exemplary.

In Patent Document 1 (Korean Patent Publication No. 10-2018-0033475), a glass cleaning device is disclosed. The glass cleaning device includes an electrode and a hydrophobic layer on a windshield of a vehicle. When liquid droplets form on the hydrophobic layer, which is the surface layer, the glass cleaning device moves the liquid droplets to the outside of the windshield by applying a voltage to the electrode to perform cleaning.

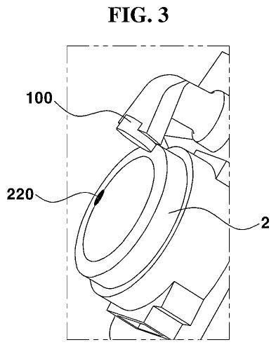

The foreign matter removal device according to the present disclosure is capable of removing not only liquid foreign matter attached to the environmental sensor, but also solid foreign matter in a non-liquid state. For example, the foreign matter removal device according to the present disclosure may use the cleaning method of Patent Document 1 to not only clean liquid droplets but also solid foreign matter by hydrating solid foreign matter. As illustrated in FIG. 3, the foreign matter removal device according to the present disclosure includes a nozzle 100 disposed in the environmental sensor 2. The nozzle 100 may be the washer fluid nozzles 15a, 15b, 15c: collectively, 15 in the washer fluid cleaning system 11. In an embodiment, the foreign matter removal device may be integrated with the washer fluid cleaning system 11.

The nozzle 100 may spray a washer fluid or cleaning fluid from the washer fluid tank 13 to the environmental sensor 2, particularly, the sensing portion of the environmental sensor 2. As a non-limiting example, the cleaning fluid may include water, liquid detergent, and the like. The nozzle 100 may spray the cleaning fluid through two spraying methods: a particle spraying method and a high-pressure spraying method.

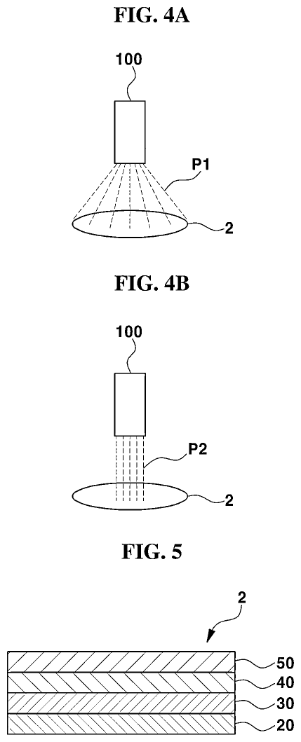

Specifically, referring to FIGS. 4A and 4B, the nozzle 100 may include a particle position P1 and a high-pressure position P2. In other words, the nozzle 100 may spray the cleaning fluid widely over the entire surface of the environmental sensor 2 at a relatively low pressure or may intensively spray the cleaning fluid at a relatively high pressure.

At the particle position P1, the nozzle 100 may spray the cleaning fluid widely over the entire surface of the environmental sensor 2 using the particle spraying method. At the high pressure position P2, the nozzle 100 may clean the environmental sensor 2 using the high-pressure spraying method.

According to an embodiment of the present disclosure, the nozzle 100 may move between the particle position P1 and the high pressure position P2 through rotation of the nozzle 100. Specifically, by rotating the nozzle 100 like a general sprayer, the nozzle 100 may be positioned at the particle position P1 or at the high pressure position P2. In one embodiment, the nozzle 100 includes a nozzle actuator 110. The nozzle actuator 110 as an electric actuator is configured to receive an operation signal and provide rotational force to the nozzle 100 to thereby move the nozzle 100 to a desired position. In some embodiments, the operation of the nozzle actuator 110 may be controlled by the controller 10 of the sensor cleaning systems 1 and 11. In another embodiment, the nozzle actuator 110 may be controlled by a controller separate from the controller 10.

As illustrated in FIG. 5, the environmental sensor 2, as described above, may include a substrate 20, a plurality of electrodes 30, an insulating layer 40, and a hydrophobic layer 50. The hydrophobic layer 50 is a surface layer in contact with the outside and repels water. Therefore, water may more easily fall off the surface of the environmental sensor 2. When hydrated foreign matter adheres to the environmental sensor 2, the controller 10 alternately applies a first direct current (DC) voltage and a second DC voltage greater than the first DC voltage to the plurality of electrodes 30. The controller 10 may apply DC voltages with different values to each electrode of the plurality of electrodes 30, thereby moving the hydrated foreign matter from the center of the surface of the environmental sensor 2 towards the outside. In some embodiments, an alternating current (AC) voltage is applied to the electrode 30 to vibrate a hydrated foreign matter, thereby moving the hydrated foreign matter on the hydrophobic layer 50, which is the surface layer of the environmental sensor 2, from the center of the surface of the environmental sensor 2 to the outside.

According to the present disclosure, the foreign matter removal device includes a foreign matter sensing portion 220. The foreign matter sensing portion 220 may detect liquid or solid foreign matter on the environment sensor 2. As a non-limiting example, the foreign matter sensing portion 220 may detect whether foreign matter is attached to the environmental sensor 2 through an image processing analysis. The foreign matter sensing portion 220 may capture an image of the environmental sensor 2 using a vision camera, etc. The foreign matter sensing portion 220 may determine whether foreign matter is present through comparison between a preset image and a captured current image of the environment sensor 2, and may also determine whether the foreign matter is solid or liquid.

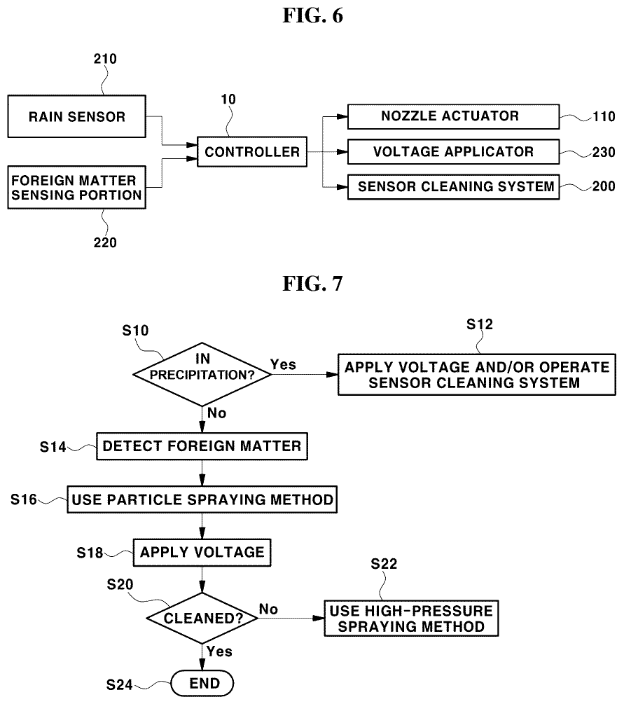

Hereinafter, the operation of the foreign matter removal device according to an embodiment of the present disclosure is described with reference to FIGS. 6 and 7.

The controller 10 may perform cleaning of the environmental sensor 2. For example, the controller 10 may be the controller 10 of the sensor cleaning system provided in the vehicle V, such as the air cleaning system 1 and/or the washer fluid cleaning system 11 described above, or may be a controller provided separately from the controller 10. In the latter case, the controller 10 may communicate with a sensor cleaning system 200 of the vehicle V, such as the air cleaning system 1 and the washer fluid cleaning system 11.

The controller 10 may control the operation of the foreign matter removal device according to the present disclosure. The controller 10 may perform cleaning of the environmental sensor 2 according to pre-stored executable commands.

The controller 10 may collect a foreign matter detection signal from the foreign matter sensing portion 220 provided in the environmental sensor 2. The controller 10 may select a spraying method of the nozzle actuator 110 based on the foreign matter detection signal of the foreign matter sensing portion 220. In some embodiments, the controller 10 may collect a rain detection signal from a rain sensor 210 provided in the vehicle V configured to detect whether it is currently raining.

The nozzle actuator 110 may receive an operation signal by the controller 10. When the controller 10 receives a foreign matter detection signal from the foreign matter sensing portion 220, the controller 10 may position the nozzle 100 at a predetermined position. For example, when solid foreign matter is attached, the controller 10 may control the nozzle actuator 110 to position the nozzle 100 at the particle position P1 to cause the solid foreign matter to be included in liquid droplets. Alternatively, when contamination of the environmental sensor 2 is severer, such as when the controller 10 receives a rain detection signal from the rain sensor 210, the controller 10 may position the nozzle 110 at the high pressure position P2 instead of the particle position P1.

The controller 10 may operate a voltage applicator 230 so that voltages are applied to the electrodes 30 of the environmental sensor 2. The voltage applicator 230 may apply an AC voltage and a DC voltage and may alternately apply the first DC voltage and the second DC voltage.

Referring to FIG. 7, the controller 10 may determine whether it is currently raining at operation S10. For example, by the detection of the rain sensor 210, the controller 10 may determine whether it is currently raining. Upon determining that it is currently raining, the controller 10 may apply a voltage to the electrode 30 using the voltage applicator 230 based on the frequency of the foreign matter detection signal of the foreign matter sensing portion 220 to perform cleaning of the environmental sensor 2 at operation S12.

When it is not currently raining, particularly, when the environmental sensor 2 is not severely contaminated, the controller 10 may normally determine whether foreign matter is present on the environmental sensor 2 using the foreign matter sensing portion 220 at operation S14. Upon determining that foreign matter, for example, solid foreign matter is attached to the environmental sensor 2, the controller 10 controls the nozzle actuator 110 to position the spraying position of the nozzle 100 at the particle position P1 in operation S16. Then a voltage is applied to the electrode 30 using the voltage applicator 230 at operation S18. When it is not raining or the like, contamination of the environment sensor 2 may not be severe. Therefore, cleaning of the environmental sensor 2 through application of a voltage may be performed to reduce the load of the sensor cleaning system 200, for example, the load of the compressor 6 of the air cleaning system 1.

Additionally, after the cleaning performed by the application of voltage, the controller 10 may determine whether the cleaning is successful in operation S20, which may be determined based on the foreign matter detection signal of the foreign matter sensing portion 220. Upon determining that the foreign matter has been removed based on the foreign matter detection signal, the process is terminated at operation S24. Upon determining that the cleaning has not been performed properly, the controller 10 operates the nozzle actuator 110 to position the nozzle 100 at the high pressure position P2 so that the cleaning fluid is sprayed from the nozzle 100 at operation S22. Therefore, according to the present disclosure, the operating frequency of the air cleaning system 1 may be reduced and the environmental sensor 2 may be kept clean at all times.

In addition, the foreign matter removal device according to the present disclosure may remove foreign matter such as solids in addition to cleaning by applying a voltage capable of only removing moisture.

As is apparent from the above description, the present disclosure provides the following effect.

The present disclosure provides a foreign matter removal device for an environmental sensor capable of effectively cleaning the environmental sensor, and a method of operating the same.

Effects of the present disclosure are not limited to the one described above, and other effects not mentioned herein should be clearly recognized by those having ordinary skill in the art based on the above description.

It should be apparent to those of ordinary skill in the art to which the present disclosure pertains that the present disclosure described above is not limited by the above-described embodiments and the accompanying drawings, and various substitutions, modifications and changes are possible within a range that does not depart from the technical idea of the present disclosure.

What is claimed is:

1. A foreign matter removal device for an environmental sensor, the device comprising:
the environmental sensor comprising a hydrophobic layer on a surface thereof and a plurality of electrodes disposed under the hydrophobic layer, wherein a voltage is applicable to the plurality of electrodes; and
a nozzle configured to spray a fluid to the environmental sensor,
wherein the voltage is applied after the nozzle sprays the fluid.

2. The device according to claim 1, wherein the nozzle is configured to:
spray the fluid by two different spraying methods and
perform low-pressure spraying at a particle position and performs high-pressure spraying at a high pressure position at which the fluid is sprayed at a higher pressure than at the particle position.

3. The device according to claim 1, further comprising a nozzle actuator configured to operate the nozzle so that the nozzle is movable between a particle position and a high pressure position.

4. The device according to claim 1, further comprising a foreign matter sensing portion configured to detect whether foreign matter is present on the environmental sensor.

5. The device according to claim 1, wherein the fluid includes water or washer fluid.

6. The device according to claim 1, further comprising:
a voltage applicator configured to apply the voltage to the plurality of electrodes; and
a controller configured to control an operation of the voltage applicator.

7. The device according to claim 1, wherein the fluid is washer fluid, and the washer fluid is stored in a washer fluid tank in fluid communication with the nozzle.

8. The device according to claim 7, further comprising a washer fluid valve disposed between the washer fluid tank and the nozzle and configured to be opened or closed.

9. The device according to claim 1, wherein the environmental sensor includes at least one of a lidar, a radar, or a camera.

10. The device according to claim 1, wherein the foreign matter removal device for the environmental sensor is provided on a vehicle.

11. A method of operating a foreign matter removal device for an environmental sensor, the method being executed by a controller, the method comprising:
detecting whether foreign matter is attached to the environmental sensor, wherein the environmental sensor comprises a hydrophobic layer on a surface thereof and a plurality of electrodes disposed under the hydrophobic layer;
spraying a fluid to the environmental sensor using a nozzle upon determining that foreign matter is present on the environmental sensor; and
alternately applying a first voltage and a second voltage, which are different from each other, to the plurality of electrodes.

12. The method according to claim 11, wherein spraying the fluid comprises:
performing, by the nozzle, low-pressure spraying at a particle position of the nozzle, and
performing, by the nozzle, high-pressure spraying at a high pressure position of the nozzle, and
wherein a spraying pressure at the high pressure position is higher than a spraying pressure at the particle position.

13. The method according to claim 12, wherein spraying the fluid comprises operating a nozzle actuator to place the nozzle at the particle position or the high pressure position.

14. The method according to claim 11, wherein detecting whether the foreign matter is attached to the environmental sensor comprises receiving a foreign matter detection signal by a foreign matter sensing portion provided in the environment sensor and configured to detect whether foreign matter is present on the environment sensor.

15. The method according to claim 11, wherein alternately applying the first and the second voltages comprises instructing a voltage applicator configured to apply voltages to the plurality of electrodes to alternately apply the first voltage and the second voltage.

16. The method according to claim 15, wherein the second voltage is greater than the first voltage.

17. A method of operating a foreign matter removal device, the method being executable by a controller, the method comprising:
detecting whether foreign matter in a non-liquid state is present on an environmental sensor, the environmental sensor comprising a hydrophobic layer on a surface thereof and a plurality of electrodes disposed under the hydrophobic layer and to which voltage is applicable;
spraying a washer fluid to the environment sensor through a nozzle; and
adjusting voltages of the plurality of electrodes.

18. The method according to claim 17, wherein the nozzle is positioned at a particle position, and the washer fluid is sprayed from the particle position using a particle spraying method.

19. The method according to claim 17, further comprising detecting whether foreign matter remains on the environmental sensor, after adjusting the voltages of the plurality of electrodes,
wherein, upon determining that the foreign matter remains, the nozzle is positioned at a high pressure position and the washer fluid is sprayed from the high pressure position using a high pressure spraying method.
